(19) United States
(12) Patent Application Publication
(10) Pub. No.: US 2008/0093974 A1
(43) Pub. Date: Apr. 24, 2008

(54) LIGHT EMISSION DEVICE AND DISPLAY DEVICE USING THE SAME

(75) Inventor: Kang-Sik Jung, Yongin-si (KR)

Correspondence Address: KNOBBE MARTENS OLSON & BEAR LLP, 2040 MAIN STREET, FOURTEENTH FLOOR, IRVINE, CA, 92614, US

(73) Assignee: Samsung SDI Co., Ltd., Suwon-si (KR)

(21) Appl. No.: 11/774,999

(22) Filed: Jul. 9, 2007

(30) Foreign Application Priority Data
Oct. 24, 2006 (KR) 10-2006-0103462

(51) Int. Cl. H01J 63/06

(52) U.S. Cl. 313/495

(57) ABSTRACT

According to an embodiment, a light emission device includes a first substrate; a second substrate opposing the first substrate; an electron emission unit located on the first substrate; a light emission unit located on the second substrate facing the first substrate; and a spacer located between the first and second substrates for resisting pressure on the first and second substrates, the spacer comprising: a base comprising a surface; a resistive layer formed over the surface of the base, the resistive layer comprising a surface; and a charge-preventing layer formed over the surface of the resistive layer; wherein the resistive layer and the charge-preventing layer comprise one or more common elements, wherein the total number of the one or more common elements in at least one of the resistive layer and the charge-preventing layer is more than about 50% of the total number of atoms contained therein.

### CROSS-REFERENCE TO RELATED APPLICATIONS

This application claims priority to and the benefit of Korean Patent Application No. 10-2006-0103462 filed on Oct. 24, 2006 in the Korean Intellectual Property Office, the disclosure of which is incorporated herein by reference in its entirety.

### BACKGROUND

1. Field

The present disclosure relates to a light emission device and a display device using the same. More particularly, the present disclosure relates to a light emission device and a display device using the same, in which charging of spacers in the light emission device is prevented.

2. Description of the Related Technology

Generally, electron emission elements are classified into those using hot cathodes as an electron emission source, and those using cold cathodes as the electron emission source.

The field emitter array (FEA) is known as an electron emission device. The FEA element typically includes an electron emission region, and cathode and gate electrodes functioning as driving electrodes for controlling electron emission of the electron emission region. The electron emission region is typically formed into a structure having a sharp tip and utilizing a material having a relatively low work function or a relatively large aspect ratio, such as molybdenum (Mo) or silicon (Si). Or the electron emission region may be formed from a carbon-based material such as carbon nanotubes, graphite, and diamond-like carbon, so as to effectively emit electrons when an electric field is formed around the electron emission regions under a vacuum atmosphere.

The electron emission elements are typically arrayed on a first substrate to constitute an electron emission device. The electron emission device is typically combined with a second substrate, on which a light emission unit having phosphor layers and an anode electrode is formed, to constitute a light emission device.

In addition to functioning as a display, the light emission device with the above structure may function as a light source for a non-emissive display. The liquid crystal display (LCD) is the most common type of non-emissive display.

The LCD includes a display panel having a liquid crystal layer, and a light emission device for supplying light to the display panel. The display panel receives the light that is emitted from the light emission device, and this light is either transmitted or blocked by operation of the liquid crystal layer to thereby realize the display of predetermined images.

The field emission-type light emission device has been proposed to replace the cold cathode fluorescent lamp (CCFL) type and light-emitting diode (LED) type light emission device.

### SUMMARY OF THE INVENTION

According to an embodiment, a light emission device includes a first substrate; a second substrate opposing the first substrate; an electron emission unit located on the first substrate; a light emission unit located on the second substrate facing the first substrate; and a spacer located between the first and second substrates for resisting pressure on the first and second substrates, the spacer comprising: a base comprising a surface; a resistive layer formed over the surface of the base, the resistive layer comprising a surface; and a charge-preventing layer formed over the surface of the resistive layer; wherein the resistive layer and the charge-preventing layer comprise one or more common elements, wherein the total number of the one or more common elements in at least one of the resistive layer and the charge-preventing layer is more than about 50% of the total number of atoms contained therein.

According to another embodiment, a light emission device includes a first substrate; a second substrate opposing the first substrate; an electron emitter formed on the first substrate and configured to emit electrons toward the second substrate; a light emitting layer formed on the second substrate and facing the first substrate, the light emitting layer configured to emit light as electrons from the electron emitter stimulates the light emitting layer; and a spacer formed between the first and second substrates, wherein the spacer comprises a structural body configured to maintain a distance between the first and second substrates, and wherein the spacer further comprises at least one layer formed on the structural body and configured to prevent charges from collecting in the spacer.

### BRIEF DESCRIPTION OF THE DRAWINGS

FIG. 1 is a partially exploded perspective view of a light emission device according to an embodiment.

FIG. 2 is a sectional view taken along line II-II of FIG. 1.

FIG. 3 is a partial perspective view of a spacer for the light emission device of FIG. 1.

FIG. 4 is a partially exploded perspective view of a light emission device according to another embodiment.

FIG. 5 is an exploded perspective view of a display device using the light emission device of FIG. 4 according to an embodiment.

### DETAILED DESCRIPTION OF THE PREFERRED EMBODIMENT

The field emission-type light emission device is a surface light source in which electrons emitted from electron emission regions excite a phosphor layer to illuminate the same. Compared to the CCFL-type and LED-type light emission devices, the field emission-type light emission device typically consumes less power, is easily manufactured to large sizes, and does not require the use of complicated optical elements.

In a light emission device, a sealing member (e.g., a frit bar) is typically located between two substrates along edge portions thereof to seal together the substrates and thus form a vacuum vessel. The pressure in the interior of the vacuum vessel is kept at a magnitude of about 10⁻⁶ Torr.

Since the vacuum vessel can receive substantial compression forces due to the difference in pressure between the interior and exterior of the vacuum vessel, a plurality of spacers may be located within the vacuum vessel. The spacers resist the atmospheric pressure applied to the vacuum vessel to thereby ensure that a gap between the substrates is uniformly maintained.

However, the spacers are exposed within the interior of the vacuum vessel at locations where electrons continuously flow such that the electrons emitted from the electron emission regions can collide with the spacers. This may result in charging of the spacers, which in turn can distort the paths of the electron beams formed by the emitted electrons.

With reference to the accompanying drawings, embodiments will be described to enable those skilled in the art to implement it. As those skilled in the art would appreciate, the described embodiments may be modified in various ways, all without departing from the spirit or scope of the present invention. Wherever possible, the same reference numbers will be used throughout the drawings to refer to the same or like parts.

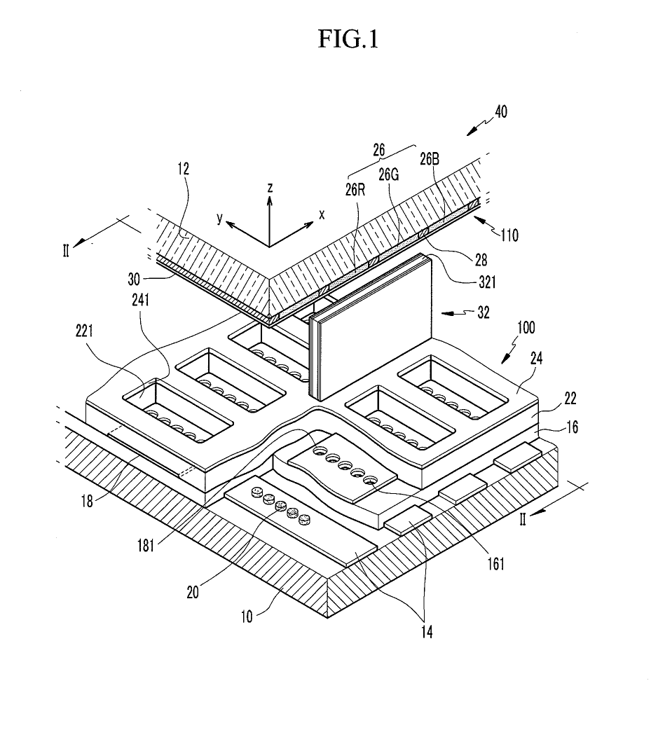

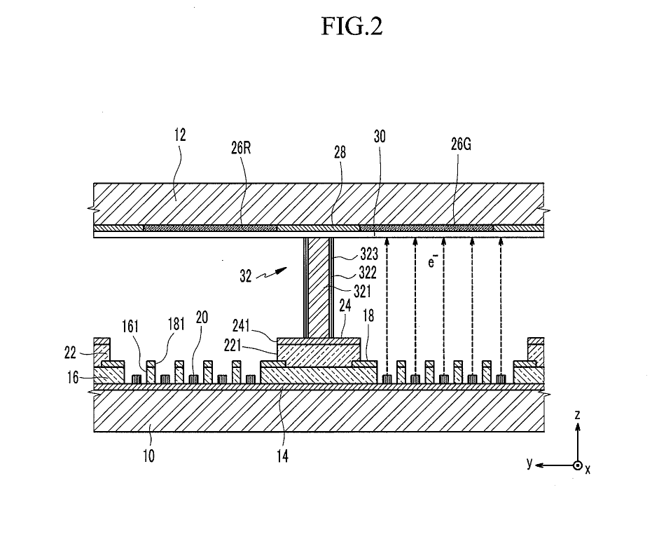

FIG. 1 is a partial exploded perspective view of a light emission device according to an embodiment, and FIG. 2 is a sectional view taken along line II-II of FIG. 1.

Referring to FIGS. 1 and 2, a light emission device 40 according to an embodiment may include a first substrate 10 and a second substrate 12 opposing each other in a substantially parallel manner and with a predetermined gap therebetween. A sealing member (not shown) may be provided between the first and second substrates 10, 12 along edge portions thereof to seal together the first and second substrates 12, 14 and thus form a vacuum vessel. The pressure in the interior of the vacuum vessel is kept at a magnitude of about 10⁻⁶ Torr.

An electron emission unit 100 formed by an array of electron emission elements may be provided on a surface of the first substrate 10 facing the second substrate 12, and a light emission unit 110 including a phosphor layer, an anode electrode, etc. may be provided on a surface of the second substrate 12 facing the first substrate 10.

The first substrate 10 having the electron emission unit 100 and the second substrate 20 having the light emission unit 110 may be combined to form a light emission device 40.

The vacuum vessel having the above structure may be applied to a variety of different types of electron emission-type displays, including but not limited to, for example, the FEA-type, SCE-type, MIM-type, and MIS-type of electron emission-type display.

Cathode electrodes 14 may be formed on the first substrate 10 in a stripe pattern along a first direction (y-axis in FIG. 1).

A first insulation layer 16 may be formed on the first substrate 10 covering the cathode electrodes 14, and gate electrodes 18 may be formed on the first insulation layer 16 in a stripe pattern along a second direction (an x-axis in FIG. 1) perpendicular to the first direction.

With this configuration, intersection regions may be formed by the intersection of the cathode electrodes 14 and the gate electrodes 18, and one of the intersection regions can form a unit pixel. A plurality of electron emission regions 20 may be formed on the cathode electrodes 14 at each area corresponding to the unit pixels.

Further, first openings 161 and second openings 181 may be formed respectively in the first insulation layer 16 and the gate electrodes 18, such that pairs of one of the first openings 161 and one of the second openings 181 can correspond in location with the electron emission regions 20 to thereby expose the electron emission regions 20. That is, the electron emission regions 20 may be located on the corresponding cathode electrodes 14 respectively within the pairs of the first and second openings 161, 181. In the illustrated embodiment, each of the electron emission regions 20 and the first and second openings 161, 181 may have a circular shape when viewed from above. However, the shape of these elements is not limited to that shown in the drawings.

According to the illustrated embodiment, the electron emission regions 20 may be formed by a material emitting electrons when an electric field is applied thereto under a vacuum atmosphere, such as a carbon-based material or a nanometer-sized material. For example, the electron emission regions 20 may be formed by materials including but not limited to carbon nanotubes, graphite, graphite nanofibers, diamonds, diamond-like carbon, fullerene (C₆₀), silicon nanowires or a combination thereof. Alternatively, the electron emission regions 20 may be formed in a tip structure formed by a molybdenum (Mo) or silicon-based (Si-based) material.

A plurality of the electron emission regions 20 may be located for each unit pixel. The plurality of the electron emission regions 20 may be arranged in a row along a lengthwise direction of the corresponding cathode electrode 14 (as in the illustrated embodiment) or the corresponding gate electrode 18 with a predetermined spacing between adjacent electron emission regions 20. However, the arrangement of the electron emission regions 20 is not limited to the particular configuration shown, and various other arrangements may be employed.

A second insulation layer 22 and a focusing electrode 24 may be formed in this order on the first substrate 10 covering the gate electrodes 18. The second insulation layer 22, which is positioned under the focusing electrode 24, can insulate the gate electrodes 18 from the focusing electrode 24.

Further, the focusing electrode 24 may be formed on the second insulation layer 22 from a single layer having a predetermined size.

Third openings 221 and fourth openings 241 may be formed respectively in the second insulation layer 22 and the focusing electrode 24 to allow for electron beams to pass through.

In the illustrated embodiment, the third openings 221 of the second insulation layer 22 and the fourth openings 241 of the focusing electrode 24 can focus all the electrons emitted respectively from the unit pixels. However, embodiments are not limited in this regard, and openings may be formed for each electron emission region such that focusing can be performed with respect to each of the electron emission regions individually.

Phosphor layers 26, e.g., red, green, and blue phosphor layers 26R, 26G, 26B, may be formed on the surface of the second substrate 12 facing the first substrate 10 with a predetermined spacing between adjacent phosphor layers 26R, 26G, 26B. Black layers 28 may be formed between adjacent phosphor layers 26R, 26G, 26B to enhance screen contrast. The phosphor layers 26 may be located in such a manner that for each of the unit pixels, there may be a corresponding phosphor layer 26.

An anode electrode 30 is formed on the phosphor layers 26 and the black layers 28. The anode electrode 30 is formed by a metal such as aluminum (Al). The anode electrode 30 may be an acceleration electrode that can receive a high voltage to maintain the phosphor layers 26 at a high electric potential state in order to attract electron beams. The anode electrode 30 may also function as enhancing luminance by reflecting visible light. That is, visible light that may be emitted from the phosphor layers 26 toward the first substrate 10 is reflected by the anode electrode 30 toward the second substrate 12.

In another embodiment, the anode electrode may be made of a transparent conductive material such as indium tin oxide. In this case, the anode electrode is located between the second substrate and the phosphor layers. In yet another embodiment, the anode electrode may be realized through a structure in which a metal layer is formed on a transparent conductive layer.

A plurality of spacers 32 may be located between the first and second substrates 10, 12 to resist atmospheric pressure applied to the vacuum vessel and thereby ensure that a gap between the first and second substrates 10, 12 is uniformly maintained.

With respect to the first substrate 10, the spacers 32 may be located on the focusing electrode 24, and with respect to the second substrate 12, the spacers 32 may be located at locations corresponding with the locations of the black layers 28 so that blocking of the phosphor layers 26 can be prevented.

In the illustrated embodiment, each of the spacers 32 may include a base layer 321 having opposite side surfaces, a pair of resistive layers 322 formed respectively on each of the side surfaces of the base layer 321, and a pair of discharge or charge-preventing layers 323 formed respectively on each of the resistive layers 322.

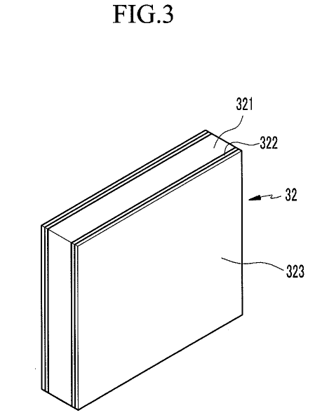

FIG. 3 is a partial perspective view of one of the spacers 32. Referring to FIG. 3, the base layer 321 may be in the form of a wall-shaped member, and is made of a material such as glass or ceramic.

The resistive layers 322 and the charge-preventing layers 323 may be sequentially formed on each of the side surfaces of the base layer 321. For example, in the illustrated embodiment, the resistive layers 322 may be formed on each of the side surfaces of the base layer 321, and the charge-preventing layers 323 may be formed on each of the side surfaces of the resistive layers 322. The resistive layers 322 and the charge-preventing layers 323 may function to discharge any charge collected on the spacers 32 due to secondary electron discharge.

The resistive layers 322 may function to supply a sufficient current to the charge-preventing layers 323, and may be made of a metal oxide or a metal nitride material, such as AlPtN, AlTiNO, or AuAlN. Metal nitride, e.g., AuAlN, undergoes minimal changes in resistance and can ensure stability with respect to the manufacturing process of the light emission device.

These materials, through a resistivity of about 1.0×10⁵Ω □ to about 1.0×10⁹Ω □, can allow for the flow of small currents on the surface of the spacers 32 such that current is supplied to the charge-preventing layers 323.

The charge-preventing layers 323 may be formed respectively on each of the surfaces of the resistive layers 322. The charge-preventing layers 323 may also have a resistance larger than that of the resistive layers 322, and discharge secondary electrons from the spacers 32. The charge-preventing layers 323 may include a highly conductive and thermally stable metal including, for example, but not limited to Cu, Al, Ag, Ni, Pt, Au, Pd, Ir, or Ru. Furthermore, the charge-preventing layers 323 may also be formed by a metal oxide containing such metals.

These metals typically have a secondary electron emission coefficient that is close to about 1 such that when electrons collide with the surfaces of the spacers 32, secondary electrons having substantially the same coefficient are discharged from the surfaces of the spacers 32. Therefore, charging of the spacers 32 can be prevented. In greater detail, the charge-preventing layers 323 may have a secondary electron emission coefficient of less than 2 with respect to electrons striking the surfaces of the spacers 32 at an angle of incidence of about 90^{°}.

The charge-preventing layers 323 may be formed by selecting atoms that form the resistive layers 322, such that the material forming the resistive layers 322 and the material forming the charge-preventing layers 323 have 50% or more of the same atoms. For example, when the resistive layers 322 are formed by aluminum (Al), platinum (Pt), and nitrogen (N), the charge-preventing layers 323 may selectively include aluminum and nitrogen atoms from among the aluminum, platinum, and nitrogen atoms.

If the material forming the resistive layers 322 and the material forming the charge-preventing layers 323 have 50% or more of the same atoms as described above, the resistive layers 322 and the charge-preventing layers 323 can have a high chemical affinity such that the interfacial adherence between them may be enhanced.

Metal typically has a crystalline structure while maintaining a solid state. Each crystal can be composed of a unit cell in which a set of atoms are arranged in a particular manner. The spacing between unit cells in various directions is referred to as its lattice parameter. In the case of an alloy formed by two or more metals, if each of the metals has a different lattice parameter, scattering of free electrons from the metals increases and thereby increases the electrical resistance, strength and hardness of the metals.

In one embodiment, the material forming the resistive layers 322 and the material forming the charge-preventing layers 323 may have about 50% or more atoms of the same element. As a result, the difference in lattice parameter between the resistive layers 322 and the charge-preventing layers 323 may be reduced to thereby enhance chemical affinity so that even when high currents are applied, stability may be maintained.

The thickness T1 for one of the resistive layers 322, and the thickness T2 for one of the charge-preventing layers 323 may be about 1 □ or less when combined (T1+T2). If this combined thickness is sufficiently thin, the base layer 321, the resistive layers 322, and the charge-preventing layers 323 of each spacer 32 may be stably joined to each other.

A temperature coefficient of resistance (“TCR”) of the spacers 32 can be less than 0.02%. That is, even when there is a temperature difference between the first and second substrates 10, 12, the spacers 32 of the illustrated embodiment may undergo minimal changes in resistance due to such a difference in temperature. Hence, the spacers 32 do not cause electron beam distortion as a result of resistance changes.

In the illustrated embodiment, although the base layers 321 are shown in a wall-shaped configuration, embodiments are not limited in this regard and the base layer 321 may be formed having various other shapes, such as round-columnar or square-columnar shapes.

Advantages of the illustrated embodiment will now be described in more detail through a comparison between two examples. However, it should be noted that embodiments of the invention are not limited to the following examples and may be realized through various embodiments within the scope of the claims. The following embodiments are provided to assist those skilled in the art to easily make and use embodiments of the invention.

As described in reference to the following first and second examples, resistive layers and charge-preventing layers may be formed on the side surfaces of the base of each spacer, and the material used for the charge-preventing layers may be varied to examine corresponding changes to the charge-preventing effect of the spacers.

### EXAMPLE 1

The base layer of each spacer was formed using the PD200 glass substrate (manufactured by Asahi Glass Company), and resistive layers and charge-preventing layers were formed in this order on each of the side surfaces of the base.

For the resistive layers, AlPtNO was used and formed to a thickness of about 4000 μm, in which the atomic % of Al:Pt:N:O was about 44.1:3.4:36.9:15.6. The resistivity of AlPtNO was measured at about 2×10⁶Ω □.

For the charge-preventing layers, AlPtNO was used and formed to a thickness of about 500 μm, in which the atomic % of Al:Pt:N:O was about 46.8:1.5:43.9:7.8. With respect to electrons accelerated to 5 kV and directed toward the surface of the spacer 32 at an incident angle of about 90°, a secondary electron emission coefficient (δ) of the charge-preventing layers was about 0.8.

The temperature coefficient of resistance (TCR) of the spacer formed using the base, resistive layers, and charge-preventing layers as described above was −1.8%.

### EXAMPLE 2

The base layer of each spacer was formed using the PD200 glass substrate (manufactured by Asahi Glass Company), and resistive layers and charge-preventing layers were formed in this order on each of the side surfaces of the base.

For the resistive layers, AlPtNO was used and formed to a thickness of about 4000 μm, in which the atomic % of Al:Pt:N:O was about 44.1:3.4:36.9:15.6. The resistivity of AlPtNO was measured about 2×10⁶Ω □.

For the charge-preventing layers, chrome oxide (Cr₂O₃), non-crystalline carbon, and WGeN were used and formed to a thickness of about 500 μm.

During manufacture of the above spacers, in the case of Example 1, joining of the surfaces between the base layer, the resistive layers, and the charge-preventing layers was stably realized. In the case of Example 2, on the other hand, either uneven growth occurred during the formation of the resistive layers and charge-preventing layers on the side surfaces of the base, or the resistive layers and the charge-preventing layers were removed from the surface of the base in a subsequent process. That is, when the resistive layers and the charge-preventing layers were not formed by atoms that are identical by an amount of about 50% or greater, either the growth was not smoothly realized, or the attachment of the grown resistive layers and charge-preventing layers was less stably maintained.

Driving of the above light emission device will now be described. The above described light emission device can be driven when predetermined external voltages are applied to the cathode electrodes 14, the gate electrodes 18, the focusing electrode 24, and the anode electrode 30.

For example, one of the cathode electrodes 14 and one of the gate electrodes 18 may function as a scan electrode receiving a scan driving voltage and the other functions as a data electrode receiving a data driving voltage.

The focusing electrode 24 may receive a negative direct current voltage that can focus electron beams of, for example, 0V or a few volts, to a few tens of volts. The anode electrode 30 can receive a direct current voltage of, for example, hundreds to thousands of volts that can accelerate electron beams.

As a result, electric fields may be formed around the electron emission regions 20 at the unit pixels where a voltage difference between the cathode and gate electrodes 14, 18 is typically equal to or higher than a threshold value, so that electrons may be emitted from the electron emission regions 20. The emitted electrons may be focused into a center of a grouping of electron beams while passing through each of the fourth openings 241 of the focusing electrode 24, and can then be attracted by the high voltage applied to the anode electrode 30 to thereby collide with the phosphor layers 26 of the corresponding unit pixels. Hence, the phosphor layers 26 can be excited to thereby realize an image.

In the above driving process of the light emission device 40 of the illustrated embodiment, the overall resistance of the spacers 32 may be reduced such that current can smoothly flow, thereby allowing for the electrons accumulated in the spacers 32 to be discharged.

Although the light emission device 40 structured as described in the above embodiments is described by way of example as having the function to perform display, it is to be understood that the light emission device 40 may also be utilized as a surface light source for a non-emissive display device.

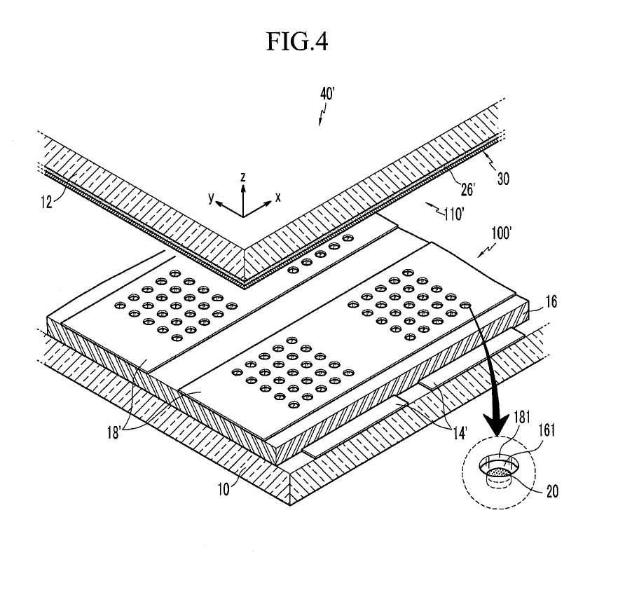

FIG. 4 is a partially exploded perspective view of a light emission device according to another embodiment. The light emission device of the present embodiment may be used as a surface light source for a non-emissive display device.

Referring to FIG. 4, a light emission device 40′ according to a second embodiment has a basic structure that is identical to that of the light emission device 40 of the first embodiment as described in FIG. 1. However, in the embodiment shown in FIG. 4, the size of the unit pixels formed by the intersection of cathode electrodes 14′ and gate electrodes 18′, the number of the electron emission regions 20 formed in each unit pixel, and the structure of the light emission unit 110′ are different than the embodiment of FIG. 1. Hence, only these different aspects of the second exemplary embodiment will be described.

In the embodiment of FIG. 4, one of the intersection regions of the cathode and gate electrodes 14′, 18′ may correspond to one pixel region of the light emission device 40′, or may correspond to two or more pixel regions of the light emission device 40′. In the first case for the intersecting cathode and gate regions corresponding with a single pixel region, the two or more of the cathode electrodes 14′ and/or the two or more of the gate electrodes 18′ may be electrically connected to thereby have the same driving voltage applied.

The light emission unit 110′ may include a phosphor layer 26′ and the anode electrode 30 located on a surface of the second substrate 12.

The phosphor layer 26′ may be realized through a white phosphor layer that emits white light. The phosphor layer 26′ may be formed on the entire active region of the first and second substrates 10, 12, or may be formed in a predetermined pattern such that one of the (white) phosphor layers 26′ can correspond in location to one of the pixel regions. The phosphor layer 26′ may also be realized by combinations of red, green, and blue phosphor layers, in which case the phosphor layers may be formed in a predetermined pattern for each of the pixel regions.

In FIG. 4, the phosphor layer 26′ is shown as a white phosphor layer located over the entire active region of the second substrate 12.

The anode electrode 30 may be formed of a metal (e.g., aluminum) covering the phosphor layer 26′. The anode electrode 30 may be an acceleration electrode that receives a high voltage to maintain the phosphor layer 26′ at a high electric potential state to attract electron beams. The anode electrode 30 may also function to enhance luminance by reflecting visible light. That is, visible light that is emitted from the phosphor layer 26′ toward the first substrate 10 may be reflected by the anode electrode 30 toward the second substrate 12.

Further, an arcing-preventing member 32 of a predetermined height may be formed on the anode electrode 30 such that when a high voltage is applied to the anode electrode 30, a resulting arcing current may be absorbed.

When the cathode and gate electrodes 14′, 18′ receive the application of predetermined driving voltages, electric fields may be formed around the electron emission regions 20 at the unit pixels where a voltage difference between the cathode and gate electrodes 14′, 18′ may be equal to or higher than a threshold value so that electrons can be emitted from the electron emission regions 20. The emitted electrons can be attracted by the high voltage applied to the anode electrode 30 to thereby strike corresponding areas of the phosphor layer 26′. As a result, the phosphor layer 26′ can be illuminated. The illumination intensity of the phosphor layer 26′ can then correspond with the electron beam emission amount for the corresponding pixels.

The gap between the first and second substrates 10, 12 of the second embodiment of FIG. 4 may be greater than the gap between the first and second substrates 10, 12 of the first described embodiment of FIG. 1, and the anode electrode 30 may be applied through anode leads (not shown) with a high voltage of about 10 kV or greater, e.g., a high voltage of between about 10 kV and about 15 kV. Since the first and second substrates 10, 12 can be separated by a large gap, the spacers located between them can be greater than those of the first described embodiment.

Accordingly, the spacers of the second described embodiment of FIG. 4 may be more effectively applied through its large size and by application of a high voltage to the anode electrode 30.

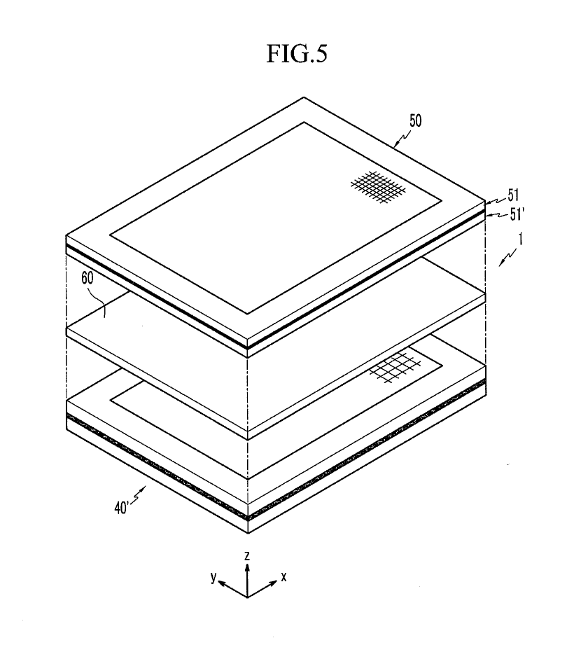

FIG. 5 is an exploded perspective view of a display device using the light emission device of the second described embodiment as a surface light source according to an embodiment.

Referring to FIG. 5, a display device 1 according to an embodiment can include a display panel 50 forming a plurality of pixels along rows and columns, and a light emission device 40′ located rearwardly of the display panel 50 for providing light to the display panel 50. In the following description, the light emission device 40′ will be referred to as a backlight unit.

The display panel 50 may be a liquid crystal display panel, in which a liquid crystal layer (not shown) is located between a pair of substrates 51, 51′, and a polarizing plate (not shown) is attached to an outer surface of the substrates. Any known liquid crystal panel may be used for the display panel.

An optical element (e.g., a heat-dispersing plate or a heat-dispersing sheet) 60 may be located between display panel 50 and the backlight unit 40′ as needed.

In this embodiment, the backlight unit 40′ forms a plurality of pixels in columns and rows. The number of pixels formed by the backlight unit 40′ may be less than the number of pixels formed by the display panel 50. That is, one of the pixels of the backlight unit 40′ can correspond with a plurality of the pixels of the display panel 50. Each of the pixels of the backlight unit 40′ may be able to display a gray scale corresponding with the highest gray scale of the corresponding pixels of the display panel 50. The backlight unit 40′ may be able to display a gray scale of 2 to 8 bits for each of its pixels.

To aid in the following description, the pixels of the display panel 50 are referred to as first pixels, the pixels of the backlight unit 40′ are referred to as second pixels, and one of the groupings of the first pixels corresponding to one of the second pixels is referred to as a first pixel group.

Driving of the backlight unit 40′ is performed in the following manner. A signal controller (not shown) for controlling the display panel 50 can detect the highest gray scale of the first pixels of the first pixel group, and can also determine the gray scale required for light illumination of the second pixels according to the detected gray scale. The controller can convert this gray scale into digital data, and generate a drive signal for the backlight unit 40′ using this digital data. Accordingly, the second pixels of the backlight unit 40′ can be synchronized with the corresponding first pixel groups when the first pixel groups display images to thereby perform light illumination at predetermined gray scales.

To aid in the description, the “row” direction may be designated as a horizontal direction (direction x) of a screen realized by the display panel 50, and the “column” direction may be designated as a vertical direction (direction y) of the screen realized by the display panel 50.

The display panel 50 may form 240 or more pixels in the row direction and the column direction, and the backlight unit 40′ may form between 2 and 99 pixels in the row direction and the column direction. If the number of the pixels of the backlight unit 40′ in the row direction and the column direction exceeds 99, driving of the backlight unit 40′ can become complicated, and costs associated with the manufacture of its drive circuitry can increase.

The backlight unit 40′ can be a self-emissive display panel having a resolution in the range of 2×2 to 99×99, and the emission intensity of the pixels may be independently controlled such that light having a suitable intensity may be supplied to the pixels of the display panel 50 corresponding with each of the pixels of the backlight unit 40′. Accordingly, the display device 50 of embodiments can increase the dynamic contrast ratio of the screen to thereby realize a sharper picture quality.

In the light emission device according to embodiments of the invention, the resistive layers having low resistance values may be formed on the spacers exposed in the vacuum vessel. As a result, the overall resistance of the spacers can be reduced so that current flow is smoothly realized, thereby allowing for charges collected on the surfaces of the spacers to be easily discharged.

The resistive layers and the charge-preventing layers formed on the surfaces of the spacers can be made of materials having 50% or more of the same atoms. As a result, the chemical affinity between these two layers can be increased such that the interfacial adherence between them may be enhanced.

Hence, the spacers according to embodiments are not charged such that distortion in the electron beams can be effectively prevented, thereby resulting in the precise illumination of the phosphor layers corresponding with the electron emission regions. Ultimately, colors may be more precisely realized and the overall picture quality enhanced.

Furthermore, the display device utilizing the above light emission device as the light source can realize an enhanced dynamic contrast ratio such that display quality can be improved, and power consumption of the light emission device can be reduced to thereby minimize overall power consumption, ultimately making the manufacture of large display devices of 30 inches or greater more feasible.

Although exemplary embodiments of the present invention have been described in detail hereinabove, it should be clearly understood that many variations and/or modifications of the basic inventive concept taught herein still fall within the spirit and scope of the present invention, as defined by the appended claims and their equivalents.

What is claimed is:

1. A light emission device, comprising:
a first substrate;
a second substrate opposing the first substrate;
an electron emission unit located on the first substrate;
a light emission unit located on the second substrate facing the first substrate; and
a spacer located between the first and second substrates for resisting pressure on the first and second substrates, the spacer comprising:
a base comprising a surface;
a resistive layer formed over the surface of the base, the resistive layer comprising a surface; and
a charge-preventing layer formed over the surface of the resistive layer;
wherein the resistive layer and the charge-preventing layer comprise one or more common elements, wherein the total number of the one or more common elements in at least one of the resistive layer and the charge-preventing layer is more than about 50% of the total number of atoms contained therein.

2. The device of claim 1, wherein the resistive layer and the charge-preventing layer comprise different resistance values.

3. The device of claim 1, wherein the charge-preventing layer comprises a secondary electron emission coefficient (δ) of about 1.

4. The device of claim 1, wherein the secondary electron emission coefficient (δ) of the charge-preventing layer with respect to electrons incident to the discharge at the angle of 90° is smaller than about 2.

5. The device of claim 1, wherein the resistive layer has a resistivity (ρ) in the range of between about 1.0×10⁵Ω □ to about 1.0×10⁹Ω □.

6. The device of claim 1, wherein the resistive layer and the charge-preventing layer have a combined thickness of less than about 1 □.

7. The device of claim 1, wherein the charge-preventing layer comprises at least one of a metal oxide and a metal nitride, wherein the metal oxide comprises at least two metals, and wherein the metal nitride comprises at least two metals.

8. The device of claim 7, wherein at least one of the metal oxide and the metal nitride comprises one or more metals selected from the group consisting of Cu, Al, Ag, Ni, Pt, Au, Pd, Ir, and Ru.

9. The device of claim 1, wherein the spacer comprises a temperature coefficient of resistance of less than about 0.02%.

10. The device of claim 1, wherein the total number of the one or more common elements in the resistive layer is more than 50% of the total number of atoms contained in the resistive layer, and wherein the total number of the one or more common elements in the charge-preventing layer is more than 50% of the total number of atoms contained in the charge-preventing layer

11. A display device, comprising:
a display panel comprising a plurality of pixels that is configured to display images; and
the light emission device of claim 1.

12. The device of claim 11, wherein the display panel is a liquid crystal display panel.
